(19) United States
(12) Patent Application Publication
(10) Pub. No.: US 2025/0334434 A1
(43) Pub. Date: Oct. 30, 2025

(54) Mass Flow Meter And Mass Flow Controller Having The Same

(71) Applicant: MICROPROGRAM INFORMATION CO., LTD., Taichung (TW)

(72) Inventor: TENG YEN WU, Taichung (TW)

(21) Appl. No.: 19/186,349

(22) Filed: Apr. 22, 2025

(30) Foreign Application Priority Data
Apr. 25, 2024 (TW) 113115506

(51) Int. Cl. G01F 1/50; G01F 1/42

(52) U.S. Cl. CPC G01F 1/50; G01F 1/42

(57) ABSTRACT

A mass flow meter includes a main member and a sensor. The main member has a main channel, a first sensor channel, a second sensor channel, and a chamber. The first and second sensor channels are connected to the main channel and the chamber respectively. The sensor is mounted within the chamber and connected to the first and the second sensor channels, so that the sensor may receive a fluid in the main channel to sense a flow rate of the fluid. The main member further has a pressure chamber, which is communicated with the main channel and the chamber, allowing a portion of the fluid flows into the pressure chamber to maintain internal and external pressure of the sensor at approximately the same level. On the other hand, a mass flow controller having the mass flow meter is also provided.

### BACKGROUND OF THE INVENTION

The present invention relates to a technique of detecting and controlling fluid flow, and more particularly to a mass flow meter capable of reducing the probability of a sensor being damaged by high-pressure fluid and a mass flow controller having the same.

A Mass Flow Controller (MFC) is a fluid flow measurement and control device that takes into account both temperature and pressure. In recent years, it has been widely used to measure and control the flow of compressible fluids such as gases and liquids. Generally, the main components of a mass flow controller include a Mass Flow Meter (MFM), a control valve, and a controller. The mass flow meter comprises a pipeline and a sensor. The pipeline serves functions such as filtration, flow stabilization, and integration of the sensor and the control valve. The sensor is used to monitor the flow rate of the fluid passing through the pipeline and transmits a flow signal to the controller. Based on this flow signal, the controller regulates the control valve to adjust the flow rate of the fluid exiting the pipeline.

It is evident that the most critical component of the aforementioned mass flow controller is the mass flow meter. Currently, the two most common types of mass flow meters available on the market are the Thermal Mass Flow Meter and the Coriolis Mass Flow Meter. The Thermal Mass Flow Meter measures flow based on the thermal diffusion effect of gases, whereas the Coriolis Mass Flow Meter operates based on the Coriolis principle.

In practice, it has been found that since the pipeline and the sensor are made of different materials (the pipeline is typically made of metal, while the sensor is made of plastic), the sensor is often damaged by the high-pressure fluid within the main member or may develop leaks. A s a result, the sensor is unable to accurately detect the flow rate of the fluid.

### SUMMARY OF THE INVENTION

In view of the above, the primary objective of the present invention is to provide a mass flow meter and a mass flow controller have the same, which is capable of reducing the probability of a sensor being damaged by high pressure fluid.

In order to achieve the objective of the present invention, the present invention discloses a mass flow meter comprising a main member and a sensor. The main member has a main channel, a first sensor channel, a second sensor channel and a chamber. The first sensor channel and the second sensor channel are communicated with the main channel and the chamber respectively. The main channel is provided with a filter. The sensor has an inlet nozzle and an outlet nozzle. The sensor is disposed within the chamber such that the inlet nozzle is connected to the first sensor channel and the outlet nozzle is connected to the second sensor channel, whereby a portion of the fluid flowing through the main channel enters the sensor via the first sensor channel and returns to the main channel via the second sensor channel, thereby allowing measurement of a flow rate of the fluid. W herein the main member further comprises a pressure chamber and an air channel, the pressure chamber is communicated with the chamber while the air channel is communicated with both the pressure chamber and the main channel, allowing a portion of the fluid in the main channel flows into the pressure chamber via the air channel to keep a pressure in the sensor identical to an outside pressure.

The present invention further discloses a mass flow controller, comprising a main member, a sensor and a control valve. The main member has a main channel, a first sensor channel, a second sensor channel, a chamber, a post-valve main channel, a first valve channel, and a second valve channel; wherein the first sensor channel and the second sensor channel are communicated with the main channel and the chamber respectively; wherein an end of the first valve channel is communicated with the main channel, and an end of the second valve channel is communicated with the post-valve main channel; wherein the main channel is provided with a filter. The sensor has an inlet nozzle and an outlet nozzle. The sensor is disposed within the chamber such that the inlet nozzle is connected to the first sensor channel and the outlet nozzle is connected to the second sensor channel, whereby a portion of the fluid flowing through the main channel enters the sensor via the first sensor channel and returns to the main channel via the second sensor channel, thereby allowing measurement of a flow rate of the fluid. The control valve has a valve inlet and a valve outlet. The control valve is disposed in the main member such that the valve inlet is connected to the first valve channel and the valve outlet is connected to the second valve channel, allowing the fluid from the main channel to flow through the control valve via the first valve channel and then flow into the post-valve main channel via the second valve channel; wherein the control valve adjusts a flow rate of the fluid discharged from the valve outlet based on the flow rate detected by the sensor. W herein the main member further comprises a pressure chamber and an air channel, the pressure chamber is communicated with the chamber while the air channel is communicated with both the pressure chamber and the main channel, allowing a portion of the fluid in the main channel flows into the pressure chamber via the air channel to keep a pressure in the sensor identical to an outside pressure.

In an embodiment, a volume of the chamber is greater than that of the sensor, so that a space is formed between the sensor and a sidewall of the chamber, the space is thereby defined as the pressure chamber.

In an embodiment, a diameter of the first sensor channel is greater than that of the inlet nozzle of the sensor, so that a space is formed between the inlet nozzle and a sidewall of the first sensor channel, the space is thereby defined as the air channel.

In an embodiment, an O-ring is disposed on the outlet nozzle of the sensor, so that the pressure chamber is hermetically sealed from the second sensor channel.

In an embodiment, further comprising a cover, the cover seals the chamber when the sensor is mounted on the chamber.

A preferred embodiment is described hereafter, accompanied with drawings, according to the objective and function of the present invention.

### BRIEF DESCRIPTION OF DRAWINGS

FIG. 1 is a perspective view of a first preferred embodiment of the present invention, showing the structure of the mass flow meter;

FIG. 2 is a sectional exploded view of the first preferred embodiment of the present invention;

FIG. 3 is a sectional assembly view of the first preferred embodiment of the present invention;

FIG. 4 is a partial enlarged view of FIG. 3; and

FIG. 5 is a sectional view of a second preferred embodiment of the present invention, showing the mass flow controller having the mass flow meter.

### DETAILED DESCRIPTION OF THE INVENTION

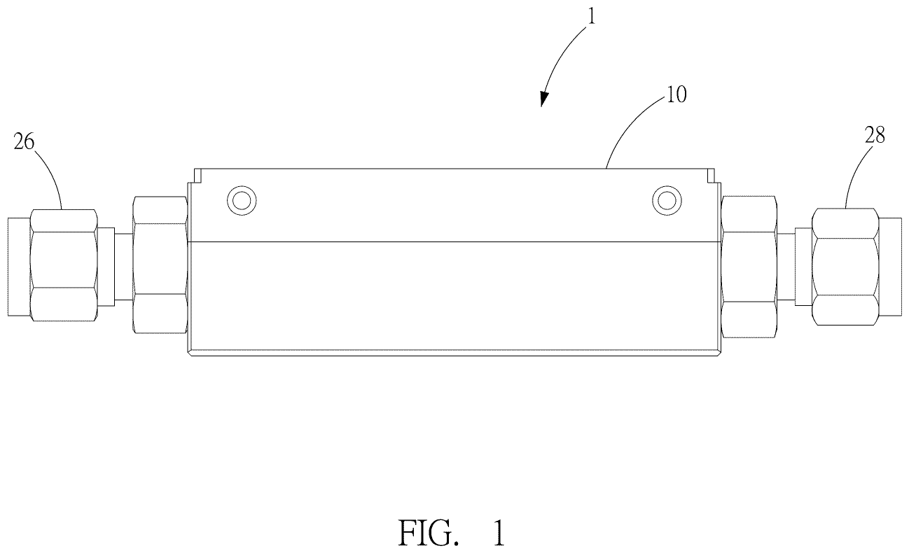

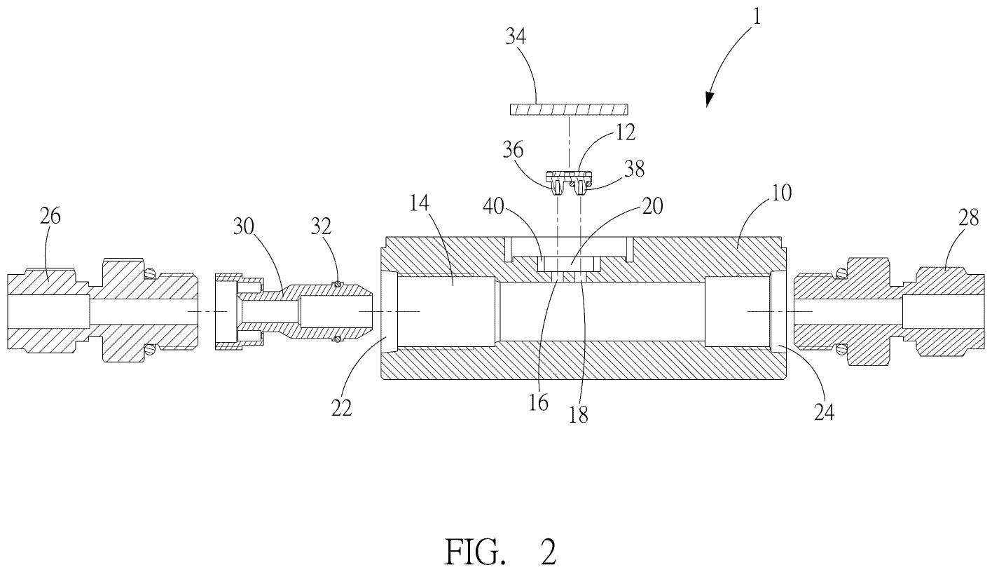

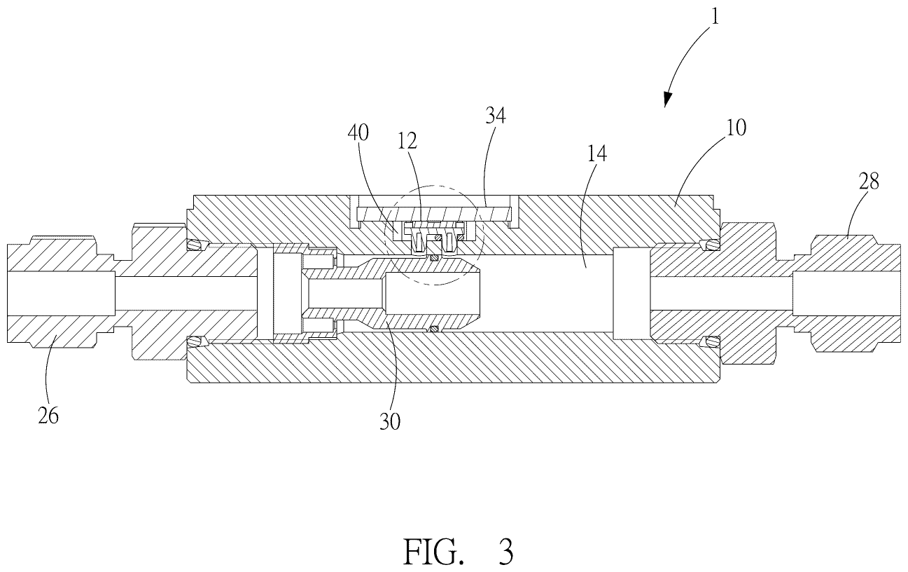

As shown in FIGS. 1 to 4, a mass flow meter 1 of a first preferred embodiment of the present invention includes a main member 10 and a sensor 12.

The main member 10 is made of metal and is provided with a main channel 14, a first sensor channel 16, a second sensor channel 18, and a chamber 20. The main channel 14 has a flow inlet 22 at an end of the main member 10 and a flow outlet 24 at the other end. Both ends of the first sensor channel 16 and the second sensor channel 18 are respectively in fluid communication with the main channel 14 and the chamber 20, with the first sensor channel 16 being located closer to the flow inlet 22 than the second sensor channel 18. A first connector 26 is connected to the flow inlet 22 for guiding a fluid into the main channel 14. A second connector 28 is connected to the flow outlet 24 for guiding the fluid out of the main channel 14. A filter 30 is disposed within the main channel 14 for filtering the fluid. A sealing ring 32 is disposed on the filter 30, abutting against a wall of the main channel 14 and positioned between the first sensor channel 16 and the second sensor channel 18, so that a portion of the fluid enters the first sensor channel 16 from an outer side of the filter 30.

A side of the chamber 20 is open at an outer surface of the main member 10. The sensor 12 is mounted within the chamber 20 and is subsequently secured to the main member 10 by means of a cover 34, thereby sealing the chamber 20. The sensor 12 includes an inlet nozzle 36 connected to the first sensor channel 16, and an outlet nozzle 38 connected to the second sensor channel 18.

Through the above configuration, the fluid entering the main channel 14 via the first connector 26 primarily flows through the filter 30, while a smaller portion of the fluid enters the sensor 12 from an outer side of the filter 30 via the first sensor channel 16, and then returns to the main channel 14 through the second sensor channel 18. In this manner, the sensor 12 is capable of detecting parameters of the fluid such as flow rate, pressure, temperature, and humidity, and generating a corresponding detection signal.

The primary feature of the present invention lies in that the main member 10 is provided with a pressure chamber 40 and an air channel 42. The pressure chamber 40 is in fluid communication with the chamber 20, and both ends of the air channel 42 are respectively in fluid communication with the pressure chamber 40 and the main channel 14, allowing a portion of the fluid passing through the main channel 14 to enter the pressure chamber 40 via the air channel 42. As a result, internal and external pressures exerted on the sensor 12 can be approximately equalized, thereby reducing the likelihood of the sensor 12 being damaged due to a high-pressure fluid entering the sensor 12.

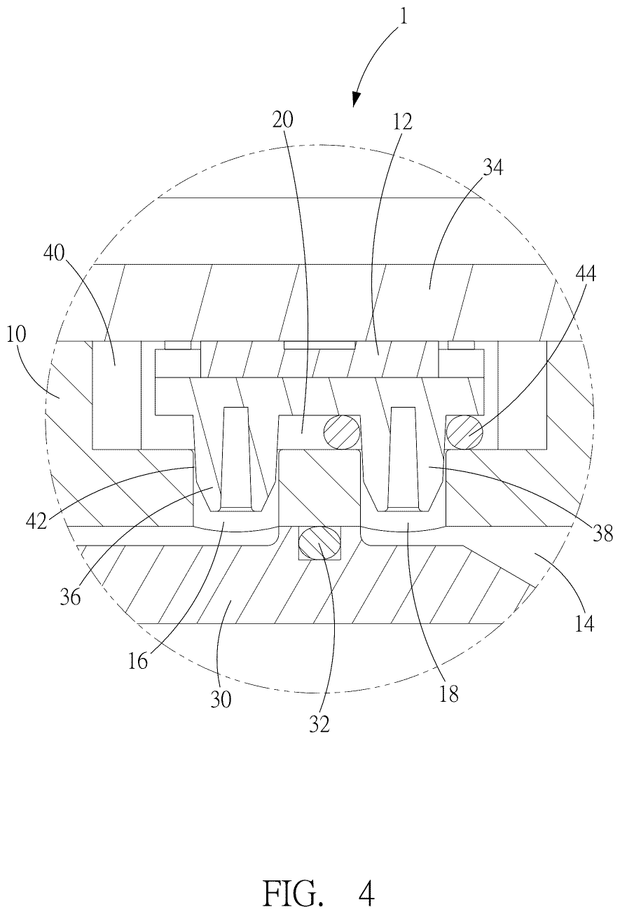

As shown in FIG. 4. In the first preferred embodiment, a volume of the chamber 20 is greater than that of the sensor 12. Therefore, after the sensor 12 is installed within the chamber 20, a space is formed between the sensor 12 and a sidewall of the chamber 20. The space is defined as the pressure chamber 40. In other words, the pressure chamber 40 is a portion of the chamber 20 that is not occupied by the sensor 12. A diameter of the first sensor channel 16 is greater than that of the inlet nozzle 36 of the sensor 12. A s a result, another space is formed between the inlet nozzle 36 and a sidewall of the first sensor channel 16, and the space is defined as the air channel 42. A majority of the fluid flowing through the first sensor channel 16 enters the sensor 12 via the inlet nozzle 36, while a smaller portion of the fluid flows into the pressure chamber 40 via the air channel 42, thereby maintaining pressure equilibrium between an interior and an exterior of the sensor 12. In practice, an O-ring 44 is provided only at the outlet nozzle 38 to ensure an airtight seal between the pressure chamber 40 and the second sensor channel 18. The inlet nozzle 36 is not provided with an O-ring, yet the aforementioned function is still achieved.

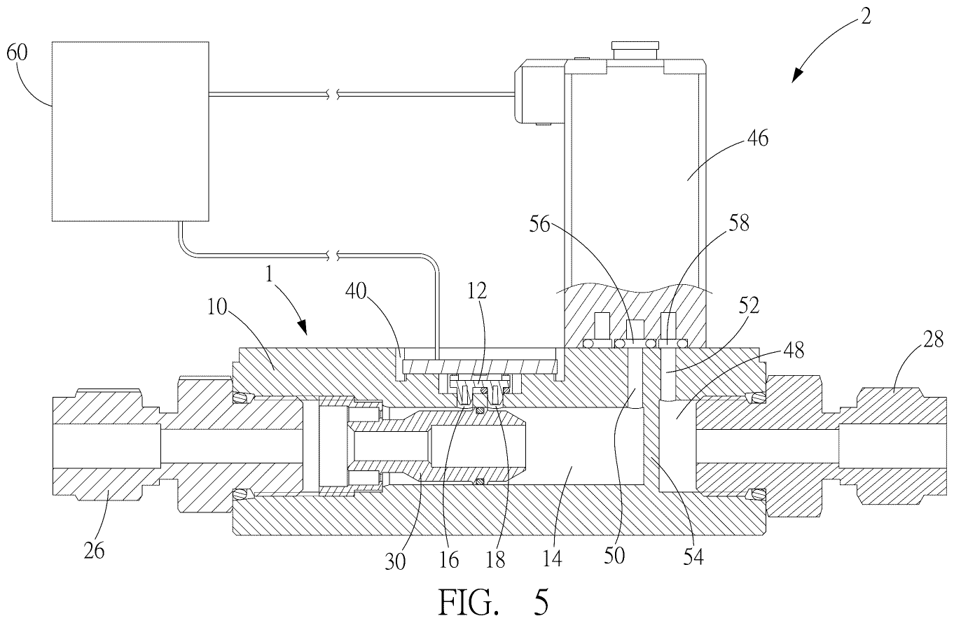

As shown in FIG. 5, a mass flow controller 2 of a second preferred embodiment of the present invention includes the mass flow meter 1 as disclosed in the first preferred embodiment, and a control valve 46.

The mass flow meter 1 includes the main member 10 and the sensor 12, wherein the main member 10 is provided with the main channel 14, the chamber 20, the first sensor channel 16, the second sensor channel 18, the pressure chamber 40 and the air channel 42. The structures of the above components are identical to those previously described and will not be repeated here. In the present preferred embodiment, the main member 10 further includes a post-valve main channel 48, a first valve channel 50, and a second valve channel 52. A partition wall 54 is disposed between the main channel 14 and the post-valve main channel 48, such that the two passages are not in direct communication. The first valve channel 50 is located on a side of the partition wall 54, with an end connected to the main channel 14. The second valve channel 52 is located on other side of the partition wall 54, with an end connected to the post-valve main channel 48. In addition, the second connector 28 is modified to be connected to an end of the post-valve main channel 48. The control valve 46 includes a valve inlet 56 and a valve outlet 58. The control valve 46 is disposed on the main member 10 such that the valve inlet 56 is connected to the first valve channel 50, while the valve outlet 58 is connected to the second valve channel 52.

By means of the above structure, the fluid entering the main channel 14 via the first connector 26 will first passes through the filter 30, then flows into the control valve 46 via the first valve channel 50, and subsequently enters the post-valve main channel 48 through the second valve channel 52, and is finally discharged via the second connector 28. As previously described, a small portion of the fluid flows from the outer side of the filter 30 into the sensor 12 via the first sensor channel 16, allowing the sensor 12 to detect a flow rate of the fluid and generate the detection signal accordingly. The detection signal is then transmitted to a processor 60. The processor 60 controls the control valve 46 based on the detection signal to adjust the flow rate of the fluid discharged from the valve outlet 58 of the control valve 46, such that the fluid within the post-valve main channel 48 is regulated to a predetermined flow rate.

As previously mentioned, the main member 10 is likewise provided with the pressure chamber 40 and the air channel 42, allowing a portion of the fluid in the main channel 14 to enter the pressure chamber 40 via the air channel 42. This arrangement helps to maintain internal and external pressure of the sensor 12 at approximately the same level, thereby reducing the likelihood of the sensor 12 being damaged by high-pressure fluid.

It must be pointed out that the embodiments described above are only some preferred embodiments of the present invention. All equivalent structures which employ the concepts disclosed in this specification and the appended claims should fall within the scope of the present invention.

1. A mass flow meter, comprising:
a main member having a main channel, a first sensor channel, a second sensor channel and a chamber; wherein the first sensor channel and the second sensor channel are communicated with the main channel and the chamber respectively;
wherein the main channel is provided with a filter; and
a sensor, having an inlet nozzle and an outlet nozzle, the sensor being disposed within the chamber such that the inlet nozzle is connected to the first sensor channel and the outlet nozzle is connected to the second sensor channel, whereby a portion of the fluid flowing through the main channel enters the sensor via the first sensor channel and returns to the main channel via the second sensor channel, thereby allowing measurement of a flow rate of the fluid;
wherein the main member further comprises a pressure chamber and an air channel, the pressure chamber is communicated with the chamber while the air channel is communicated with both the pressure chamber and the main channel, allowing a portion of the fluid in the main channel flows into the pressure chamber via the air channel to keep a pressure in the sensor identical to an outside pressure.

2. The mass flow meter of claim 1, wherein a volume of the chamber is greater than that of the sensor, so that a space is formed between the sensor and a sidewall of the chamber, the space is thereby defined as the pressure chamber.

3. The mass flow meter of claim 1, wherein a diameter of the first sensor channel is greater than that of the inlet nozzle of the sensor, so that a space is formed between the inlet nozzle and a sidewall of the first sensor channel, the space is thereby defined as the air channel.

4. The mass flow meter of claim 2, wherein an O-ring is disposed on the outlet nozzle of the sensor, so that the pressure chamber is hermetically sealed from the second sensor channel.

5. The mass flow meter of claim 1, further comprising a cover, the cover seals the chamber when the sensor is mounted on the chamber.

6. A mass flow controller, comprising:
a main member having a main channel, a first sensor channel, a second sensor channel, a chamber, a post-valve main channel, a first valve channel, and a second valve channel; wherein the first sensor channel and the second sensor channel are communicated with the main channel and the chamber respectively; wherein an end of the first valve channel is communicated with the main channel, and an end of the second valve channel is communicated with the post-valve main channel; wherein the main channel is provided with a filter;
a sensor, having an inlet nozzle and an outlet nozzle; wherein the sensor is disposed within the chamber such that the inlet nozzle is connected to the first sensor channel and the outlet nozzle is connected to the second sensor channel, whereby a portion of the fluid flowing through the main channel enters the sensor via the first sensor channel and returns to the main channel via the second sensor channel, thereby allowing measurement of a flow rate of the fluid; and
a control valve having a valve inlet and a valve outlet; wherein the control valve is disposed in the main member such that the valve inlet is connected to the first valve channel and the valve outlet is connected to the second valve channel, allowing the fluid from the main channel to flow through the control valve via the first valve channel and then flow into the post-valve main channel via the second valve channel;
wherein the control valve adjusts a flow rate of the fluid discharged from the valve outlet based on the flow rate detected by the sensor;
wherein the main member further comprises a pressure chamber and an air channel, the pressure chamber is communicated with the chamber while the air channel is communicated with both the pressure chamber and the main channel, allowing a portion of the fluid in the main channel flows into the pressure chamber via the air channel to keep a pressure in the sensor identical to an outside pressure.

7. The mass flow controller of claim 6, wherein a volume of the chamber is greater than that of the sensor, so that a space is formed between the sensor and a sidewall of the chamber, the space is thereby defined as the pressure chamber.

8. The mass flow controller of claim 6, wherein a diameter of the first sensor channel is greater than that of the inlet nozzle of the sensor, so that a space is formed between the inlet nozzle and a sidewall of the first sensor channel, the space is thereby defined as the air channel.

9. The mass flow controller of claim 8, wherein an O-ring is disposed on the outlet nozzle of the sensor, so that the pressure chamber is hermetically sealed from the second sensor channel.

10. The mass flow controller of claim 6, further comprising a cover, the cover seals the chamber when the sensor is mounted on the chamber.
